(19) United States
(12) Patent Application Publication
(10) Pub. No.: US 2022/0129695 A1
(43) Pub. Date: Apr. 28, 2022

(54) BILEVEL METHOD AND SYSTEM FOR DESIGNING MULTI-AGENT SYSTEMS AND SIMULATORS

(71) Applicant: Huawei Technologies Co., Ltd., Shenzhen (CN)

(72) Inventors: David MGUNI, London (GB); Tian ZHENG, London (GB); Yaodong YANG, London (GB)

(21) Appl. No.: 17/570,126

(22) Filed: Jan. 6, 2022

Related U.S. Application Data
(63) Continuation of application No. PCT/EP2020/065455, filed on Jun. 4, 2020.

(51) Int. Cl. G06K 9/62; G06N 20/00

(52) U.S. Cl. CPC G06K 9/6227; G06N 20/00; G06K 9/6277; G06K 9/6262

(57) ABSTRACT

A computer-implemented system and method learn an optimized interacting set of operational policies for implementation by multiple agents, where each agent is capable of learning an operational policy of the interacting set of operational policies. The system includes a first framework sub-system and a second framework sub-system. The first framework sub-system is configured modify one or both of reward functions and transition functions of a stochastic game undertaken by a plurality of agents in a simulated environment of the second framework sub-system; and update the reward and/or the transition functions based on feedback from the second framework sub-system. The system may generate policies that are capable of coping with deviations in the domains in which they are deployed and may perform alterations to the environment so as to induce optimal system outcomes.

### CROSS-REFERENCE TO RELATED APPLICATIONS

This application is a continuation of International Application No. PCT/EP2020/065455, filed on Jun. 4, 2020, the disclosure of which is hereby incorporated by reference in its entirety.

### FIELD

The present disclosure relates to multi-agent machine learning systems.

### BACKGROUND

Multi-agent reinforcement learning (MARL) offers the prospect of enabling independent, self-interested agents to learn to act optimally in unknown multi-agent systems. A central goal of MARL is to successfully deploy reinforcement learning (RL) agents in environments with a number of interacting agents. Examples include autonomous cars, network packet deliveries and search and rescue drone systems.

In a multi-agent setting, a successful RL policy is one that solves tasks in an environment in which agents affect the task performance of other agents. Deploying agents with prefixed policies that have been trained in idealised simulated environments runs the risk of very poor performance and unanticipated behaviour when these polices are placed in unfamiliar situations. When policies pretrained on simulated environments are deployed within real-world settings, even slight deviations from the physical behaviours in the simulated environment can severely undermine system performance.

Additionally, system identification, the process by which parameters of a simulator are tuned to match that of a real-world system, is often subject to large errors which can be as a result of unmodelled effects that occur over time.

Another issue which may arise is that although independent MARL agents seek to find actions that optimise their individual rewards, the Nash equilibrium (NE) outcomes produced by independent optimisers are in general highly inefficient at a system level.

The issue of system efficiency has previously been addressed through modification of the agents' reward functions. In U.S. Pat. No. 8,014,809 B2, a potential game framework describes the network control between a multi-antenna access point and mobile stations. In CN105488318 A potential game framework is used to solve large-scale sudoku problem. In EP3605334 A1, a hierarchical Markov game framework uses Bayesian optimisation for finding optimal incentives.

However, the inventors have recognized that these methods offer a limited solution. If a traffic scenario is considered in which the high level goal is to reduce congestion, reward-based mechanisms are limited to introducing tolls which is not possible in all traffic network systems. The ability of such a mechanism to produce the desired outcome is also limited.

Therefore, the inventors have recognized that it is desirable to develop an improved method for developing MARL systems that overcomes these problems.

### SUMMARY

According to one aspect of the present disclosure, there is provided a computer-implemented system for learning an optimized interacting set of operational policies for implementation by multiple agents, each agent being capable of learning an operational policy of the interacting set of operational policies, the system comprising a first framework sub-system and a second framework sub-system, the first framework sub-system being configured to: modify one or both of reward functions and transition functions of a stochastic game undertaken by a plurality of agents in a simulated environment of the second framework sub-system; and update the reward and/or the transition functions based on feedback from the second framework sub-system.

This framework may generate a set of operational policies that are capable of coping with deviations in the domains in which they are deployed and may perform alterations to the environment so as to induce optimal system outcomes. Additionally, this may lead to an optimal Nash equilibrium outcome.

The first framework sub-system may be configured to update the reward and/or the transition functions based on the modification of the one or both of the reward functions and the transition functions. This may allow the reward and/or the transition functions to be iteratively updated based on the performance of the second sub-system in a previous iteration.

The first framework sub-system may be implemented as a higher level reinforcement learning agent and the second framework sub-system may be implemented as a multi-agent system, wherein the behaviour of each individual agent in the multi-agent system is driven by multi-agent reinforcement learning. This may allow for improved operational policies to be generated in a MARL framework.

The first framework sub-system may comprise a higher level agent and the second framework sub-system may comprise a plurality of lower level agents, the higher level agent being configured to modify the one or more of the reward functions and the transition functions of a stochastic game undertaken by the plurality of lower level agents in the simulated environment and update the reward and/or the transition functions based on feedback from the plurality of lower level agents. The plurality of agents of the second framework sub-system may be self-interested agents. The second framework sub-system may be a multi-agent framework system, wherein the behaviour of a plurality of self-interested agents is simulated using multi-agent reinforcement learning. This may allow the framework to be implemented in applications such as autonomous cars, network packet deliveries and search and rescue drone systems.

The higher level agent may be configured to iteratively update the reward and/or the transition functions of the plurality of lower level agents based on the feedback from the plurality of lower level agents. This iterative approach may allow for a continual improvement of the policies assigned during initialization towards a set of optimized policies.

The outcome of the stochastic game may generate feedback for the first framework sub-system. This may allow a higher level agent of the first framework sub-system to adjust the reward and/or transition functions in dependence on the received feedback.

The second framework sub-system may be a multi-agent system, wherein the multi-agent system is configured to reach an equilibrium. The equilibrium may be a Nash equilibrium. This may allow the second frame-work subsystem to reach a stable state during training.

The first framework sub-system may be configured to modify the reward functions and/or the transition functions using gradient-based methods. The first sub-system may use gradient feedback from the behavior of the second framework sub-system in order to perform its iterative updates. This may make the framework system more data efficient and may lead to shorter training times and reduced costs.

The first framework sub-system may have at least one objective external to objective(s) of the plurality of agents of the second framework sub-system. The objective may depend on the outcome of the game which is played by the agents of the second sub-system. This may enable the higher level agent of the first framework sub-system to induce a broad range of desired outcomes.

The first framework sub-system may be configured to construct a sequence of simulated environments by modifying the reward and transition functions of the stochastic game undertaken by the plurality of agents of the second framework sub-system in each simulated environment. This may allow an optimal environment for the agents to learn an optimized set of policies in to be achieved. The environment may be a worst-case simulated environment.

The first framework sub-system may be further configured to assess whether the updates to the reward functions and transition functions have produced a set of optimal policies. This may help to indicate that the learning process may conclude so that the optimal policies can be used in real-world environments.

The first framework sub-system may be configured to generate a sequence of unseen environments. This can help the system to generate policies that are capable of coping with deviations in the domains in which they are deployed and may perform alterations to the environment so as to induce optimal system outcomes.

The stochastic game may be a Markov game. The stochastic game may be a stochastic potential game or a zero- or nonzero-sum n-player stochastic game (including a two-player stochastic game). Stochastic games may include games that do not satisfy the Markov property. Training in a simulator using these types of games may allow for the learning of optimal policies for use in real word environments.

The plurality of agents of the second framework sub-system may be at least partially autonomous vehicles, preferably autonomous vehicles, and the policies may be driving policies. In a traffic system, altering the transition dynamics corresponds to changing traffic light behavior which is an implementable mechanism in a number of traffic network systems. Moreover, changing traffic light behavior can in some circumstances offer the ability of achieving optimal system outcomes in a way that introducing tolls cannot.

The first framework sub-system may be configured to generate the simulated environment. A different environment may be generated for each iteration of the process. This may allow the optimal environment to be found.

The second framework sub-system may be configured to assign an initial operational policy to each of the plurality of agents of the second framework sub-system. At least some of the initial operational policies and/or the optimized set of operational policies may be different operational policies. The second framework sub-system may be configured to generate the feedback for the first framework sub-system based on the performance of the plurality of agents in the simulated environment. This may result in an optimized set of operational policies for the agents in the multi-agent system.

The second framework sub-system may be configured to update the initial operational policies based on the feedback. The second framework sub-system may be configured to perform an iterative machine learning process comprising repeatedly updating the operational policies until a predetermined level of convergence is reached. This may allow the optimized set of policies to be efficiently learned.

The first framework sub-system may be configured to perform an iterative machine learning process comprising repeatedly updating the one or both of the reward functions and the transition functions until a predetermined level of convergence is reached. This may allow the optimal environment to be reached.

At least some of the optimized interacting set of operational policies may be at least partially optimal policies for their respective agent. The optimized set of operational policies may result in the best overall performance of the plurality of agents. The predetermined level of convergence may be based on (and the optimized set of operational policies may represent) the Nash equilibrium outcomes for the agents. This can represent a highly optimized model of agent behaviour.

According to a second aspect of the present disclosure, there is provided a computer-implemented method for learning an optimized interacting set of operational policies for implementation by multiple agents, each agent being capable of learning an operational policy of the optimized interacting set of operational policies, the system comprising a first framework sub-system and a second framework sub-system, the method comprising: modifying, by the first framework sub-system, one or both of reward functions and transition functions of a stochastic game undertaken by the plurality of agents in a simulated environment of the second framework sub-system; and updating the reward and/or the transition functions based on feedback from the second framework sub-system.

The method may lead to an optimal Nash equilibrium outcome. Additionally, the method may generate policies that are capable of coping with deviations in the domains in which they are deployed and may perform alterations to the environment so as to induce optimal outcomes.

The method may comprise assigning an initial operational policy to each of the plurality of agents of the second framework sub-system. At least some of the initial operational policies and/or the optimized set of operational policies may be different operational policies. The method may further comprise updating the initial operational policies based on the feedback. The method may comprise performing an iterative machine learning process comprising repeatedly updating the operational policies until a predetermined level of convergence is reached.

Each of the optimized set of operational policies may be at least partially optimal policies for their respective agent. The predetermined level of convergence may be based on (and the optimized set of operational policies may represent) the Nash equilibrium behaviours of the agents. This can represent a highly optimized model of agent behaviour.

According to a third aspect of the present disclosure, there is provided a data carrier storing in non-transient form a set of instructions for causing a computer to perform the method described above. The method may be performed by a computer system comprising one or more processors programmed with executable code stored non-transiently in one or more memories.

### BRIEF DESCRIPTION OF THE FIGURES

The present disclosure will now be described by way of example with reference to the accompanying drawings. In the drawings:

FIG. 1 schematically illustrates an overview of a bilevel hierarchical system.

FIG. 2 schematically illustrates an example of a bilevel hierarchical MARL system.

FIG. 3 schematically illustrates an example of an equation for a quantity to be maximised for each agent i∈ [symbol] to determine a policy πᵢ(θ)∈Πᵢ.

FIG. 4 shows an example of an equation used by the higher level agent to find θ*.

FIG. 5 shows an example of an algorithm describing the workflow of the method.

FIG. 6 summarises a computer-implemented method for learning an optimized interacting set of operational policies for implementation by multiple agents.

FIG. 7 shows a schematic diagram of a computer system configured to implement the method described herein and some of its associated components.

### DETAILED DESCRIPTION

Described herein is a computer implemented framework for MARL with a bilevel structure comprising two framework systems having different hierarchies that can tune the transition dynamics of a game environment (one of both of the rewards functions and transition functions) played by learning agents. In a preferred embodiment, the tuning is performed by a high level agent (HLA) that uses reinforcement leaning to learn how to achieve a high level goal (i.e. in order to maximize its own external objective).

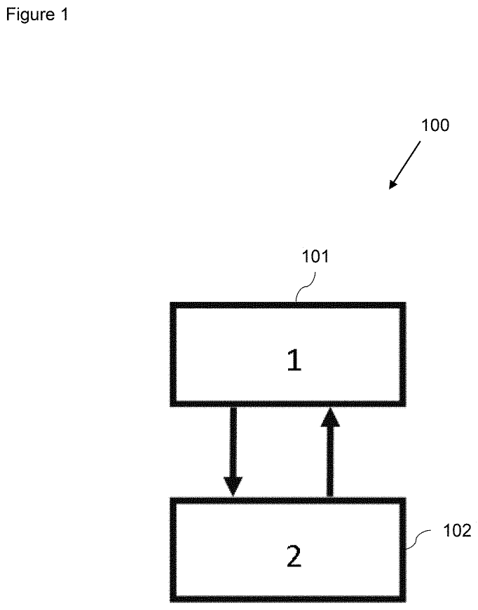

FIG. 1 schematically illustrates an overview of the exemplary structure of the bilevel framework 100 described herein. The framework has a bilevel hierarchical structure. A first framework sub-system 101 is higher level framework. The first framework sub-system 101 comprises a higher level agent. A second framework sub-system 102 is a lower level framework. The second framework sub-system 102 comprises a plurality of agents or actors. Each of the agents or actors is capable of learning an operational policy in a simulated environment.

During initialisation, the second framework sub-system 102 is configured to assign an initial operational policy to each of a plurality of agents of the second framework sub-system 102. The initial operational policy assigned to each agent is a candidate policy from which the optimized interacting set of policies are learned in an iterative machine learning process. Each of the learned policies may be an at least partially optimal policy for its respective agent. The optimized set of learned policies may represent the Nash equilibrium outcome for the agents of the second framework sub-system.

As will be described in more detail below, the higher level agent generates new environments through alterations of the simulator transition model or the reward functions of the lower level system. It may construct a sequence of simulation environments by tuning the reward and transition functions to generate desirable outcomes and policies that emerge in the lower level system.

The higher level agent of the first framework subsystem 101 can therefore modify one or both of the reward functions and the transition functions of a stochastic game undertaken by the plurality of agents in a simulated environment of the second framework sub-system. It can update the reward and/or the transition functions based on feedback from the second framework sub-system such that the plurality of agents may learn an optimized set of interacting policies to achieve the optimal lower-level system performance.

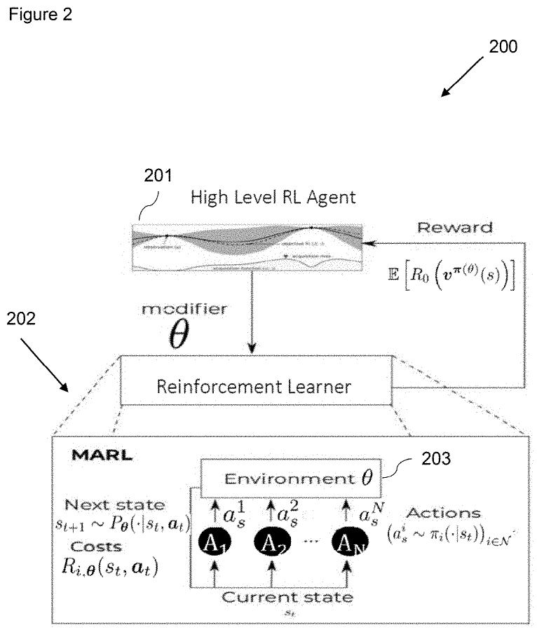

FIG. 2 schematically illustrates one embodiment of the system framework 200 and its operation in more detail. In this embodiment of the two-level system, the first framework sub-system is implemented as a higher level RL agent while the second framework sub-system is implemented as a multi-agent system, where each individual agent's behaviour in environment 203 is driven by multi-agent RL. The HLA of the first framework sub-system is shown at 201. The second framework sub-system is shown generally at 202.

The HLA 201 modifies one or both of the reward functions and the transition functions of a stochastic game which is played by the set of agents (also referred to as actors, or followers) of the second sub-system in a simulated environment 203. The HLA has its own goals i.e. some external objective which enables the HLA to induce a broad range of desired outcomes.

In a preferred example, the framework is a gradient-based bilevel framework that learns how to modify either or both of the agents' rewards and the transition dynamics to achieve optimal system performance. The higher level RL agents simulates the NE outcomes of MARL learners while performing gradient-based updates to the reward functions and transition function until optimal system performance is reached. In other words, the higher-level RI, agent is an external agent that constructs a sequence of simulation environments by tuning the reward and transition functions to generate desirable outcomes and policies that can cope with unexpected changes in the transition dynamics.

In this embodiment, the higher-level agent controls the reward and/or the transition dynamics of the environment 203, denoted by θ, the lower-level RL system 202. The lower-level system 202 is a multi-agent system, where each agent plays the multi-agent game by selecting its own action aᵢ from its policy πᵢ given the input state of the system sₜ. Altogether there are N number of agents. After receiving the actions from all agents (aₛ¹, aₛ², . . . , aₛ^{N}), the environment transits to the next state sₜ₊₁ following the transition dynamics Pₑ, and then each agent receives its own reward determined by the function R_{i,θ} which is essentially a function of all agents' actions and the environmental state. The function R_{i,θ} determines the reward for agent i.

The behavior of the multi-agent system 200 is described below by a Markov game framework whose stable behavior is simulated using reinforcement learning agents that learn the stable behaviour. In general, the method may apply to any stochastic game, such as a stochastic potential game or a zero- or nonzero-sum n-player stochastic game (including a two-player stochastic game). Stochastic games may include games that do not satisfy the Markov property.

Markov games (MGs) are mathematical frameworks that can be used to study multi-agent systems (MASs). In the following example, a bilevel framework is considered that involves a HLA and a set of RL agents (followers). The followers play a MG [symbol] (θ′) where θ∈Θ⊆ [symbol] ^{q} for some q∈\ [symbol] is a parametrization over the transition functions and the reward functions of the game. In particular, for any game [symbol] (θ), the parameter θ is selected according to a policy that the HLA chooses in advance of the N agents playing [symbol] (θ).

In this setting, the subgame played by the agents is an n-player nonzero-sum MG. An MG is an augmented Markov decision process (MDP) which proceeds by two or more agents taking actions that jointly manipulate the transitions of a system over T∈ [symbol] rounds which may be infinite. At each round, the agents simultaneously play one of many possible different games or stage games which are indexed by states.

Formally, consider an MG defined by a tuple [symbol] = [symbol] ,( [symbol] , P_{θ}, (R_{i,θ} [symbol] , [symbol] ,γ [symbol] where [symbol] is a finite set of states, [symbol] ᵢ is an action set for each agent i∈ [symbol] and [symbol] :={1, . . . , N} is the set of agents and the function R_{i,θ}: [symbol] ᵢ→ [symbol] is the one-step reward for agent i which is parameterized by θ∈Θ. The map P_{θ}: [symbol] × [symbol] ₁×× . . . [symbol] _{N}× [symbol] →[0,1] is a Markov transition probability matrix which is parameterized by θ∈Θ, i.e. P_{θ}(s′|s, aₛ) is the probability of the state s′ being the next state given the system is in state s and the joint action aₛ∈ [symbol] = [symbol] [symbol] ᵢ is played.

Therefore the MG proceeds as follows: given some stage game [symbol] (s)= [symbol] ( [symbol] ᵢ [symbol] ,( [symbol] the agents simultaneously execute a joint action and immediately thereafter, each agent i∈ [symbol] receives a payoff Rᵢ(s, aₛ), the state then transitions to s′∈S with probability P_{θ}(s′|s, aₛ) where the game [symbol] (s′) is played in which the agents receive a reward which is discounted by γ∈[0, 1).

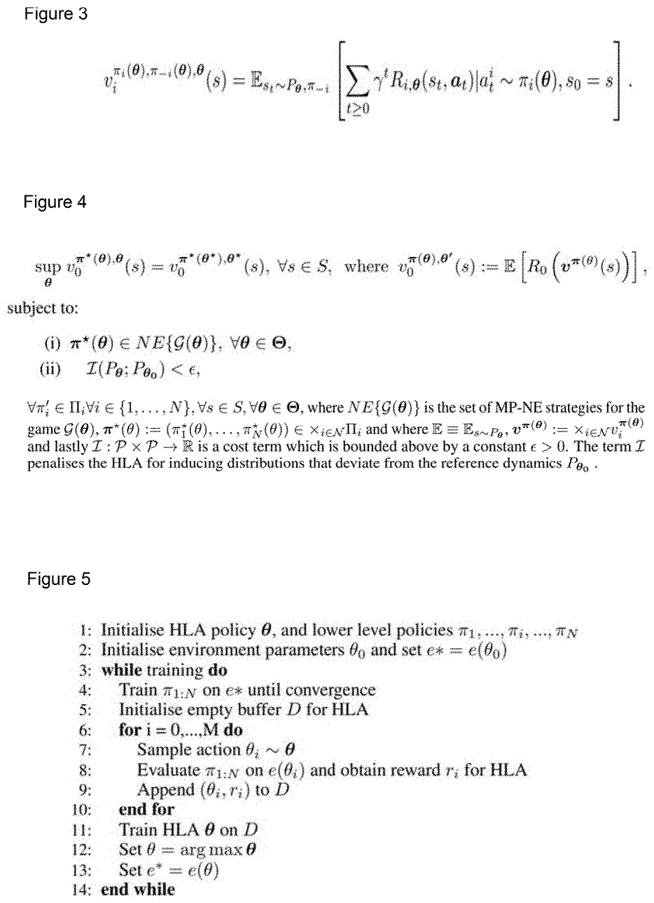

Given an observation of the state, each agent employs a stochastic policy πᵢ(θ)∈Πᵢ to decide its actions ∈ [symbol] . For an MG [symbol] (θ), the goal of each agent i∈ [symbol] is to determine a policy πᵢ(θ)∈Πᵢ that maximises the quantity shown in FIG. 3. π(θ):=(π₁(θ), . . . , π_{N}(θ))∈ [symbol] Πᵢ denotes the joint policy for all agents playing [symbol] (θ); θ∈Θ.

The HLA has an objective that depends on the outcome of the game [symbol] (θ) which is played by followers. A problem facing the HLA is to find a θ* that maximises the HLA's expected reward. In particular, facing the HLA is defined by the tuple [symbol] Θ, R₀, F [symbol] , where R₀: [symbol] ^{N}→ [symbol] is the HLA reward function and Θ⊂ [symbol] ^{q} is an q-dimensional action set.

Therefore, a problem for the HLA is to find θ* according to the exemplary equation shown in FIG. 4.

The order of events is therefore as follows: the HLA chooses the parameter θ′∈Θ. Immediately thereafter, the N agents then play [symbol] (θ′) and upon termination of the game, the HLA receives its reward which is determined by the outcome of [symbol] (θ′). The action set for the HLA, Θ, is a space of parametric values over which the transition function P_{θ} and the reward functions R_{i,θ} for i=1, 2, . . . , N are defined.

The NE condition (i) shown in FIG. 4 can therefore enter the HLA's problem as a constraint which defines that the agents execute rational responses within their subgame. Condition (ii) shown in FIG. 4 is a constraint on how much the HLA may alter the transition dynamics of the agents' subgame given some reference set of dynamics P_{θ0} given some penalisation measure I. The term I penalises the HLA for inducing distributions that deviate from the reference dynamics P_{θ0}.

The general order of events for the system is therefore as follows: the HLA of the first framework sub-system chooses the parameter θ∈Θ to create the environment for the second framework sub-system. The plurality of agents of the second framework sub-system then play the stochastic game and upon termination of the game, the HLA receives its reward which is determined by the outcome of the stochastic game.

The HLA 201 can therefore generate a sequence of unseen (simulated) environments for the set of agents to play in. This occurs in simulation. The optimal environment and the associated policies can be found. The behaviour of the self-interested agents is simulated using (MA)RL.

One instantiation of the method is a min-max problem. This may generally lead to the best MARL policy performance in worst-case scenarios, as described in more detail below. Formulating the problem as a min-max problem may help to guarantees performance in a range of environments.

The generated policies may lead to an optimal Nash equilibrium outcome. Additionally, the framework can generate policies that are capable of coping with deviations in the domains in which they are deployed and may perform alterations to the environment so as to induce optimal system outcomes, as well as outcomes that are robust against model misspecification.

The framework can therefore use a combination of reinforcement learning algorithms to compute the agents' policies with policy-gradient RL methods. This method finds the optimal alterations to the game (by tuning of the transition dynamics) whilst ensuring the agents' execute their NE policies. The use of RL solves a problem of analytic intractability since the RI, component does not require the use of analytic theory to compute the solution. In contrast to an existing methods for reward design that do not exploit gradients (such as Bayesian optimization), using a gradient-based approach may lead to increased computational efficiency.

The bilevel framework learns how to alter existing multi-agent environments to achieve some desired outcome through alterations of the simulator transition model. Furthermore, it learns how to generate desirable agent behaviour in a multi-agent system through a) alterations of the agents' individual reward functions b) by constructing simulated environments which, as training environments for reinforcement agents, lead to the agents learning desirable behaviour when deployed in real-world systems.

As described above, to achieve this, the HLA constructs a sequence of simulation environments by tuning the reward and transition functions. During this time, the stable (equilibrium) outcomes of MARL learners are simulated while performing gradient-based updates to the reward functions and transition functions until policies that exhibit the required desirable properties (i.e. produce optimal system outcomes, and are robust to system changes) are produced and validated. The lower-level system outputs the feedback of the equilibrium to the higher-level agent so that the higher-level agent can tune and adjust the reward and/or the transition dynamics in the next iteration for the lower-level agents to better induce desired behaviours of equilibrium.

In some embodiments, the first framework sub-system may tune both rewards and transition functions played by learning agents. The second framework sub-system system tuned by the first framework sub-system may use RL. The first framework sub-system may generate a sequence of unseen (simulated) environments. The higher level agent of the first framework sub-system may find the optimal environment. The optimal environment may be the environment in which the optimized set of operational policies are learned. The second framework sub-system can be a multiagent system where the behaviour of self-interested agents is simulated using MARL. The outcomes of the game in the second framework sub-system may generate the feedback for the HLA of the first framework sub-system.

In some embodiments, the first framework sub-system may randomise across different environments. As discussed above, the key components of an environment are the transition dynamics and the reward function. Here, by randomising across environments, the simulator may randomly pick simulated settings with different transition functions. This may allow the agents to train against different environments. The first framework sub-system may find the worst-case environment. These are environments in which the agents would perform the worst. These may be extreme settings. For example, in the autonomous vehicle case, this could be extreme weather conditions. In the framework described herein, bounds may be set to limit how bad these worst case scenarios may be.

Policies learned in the worst-case environment may allow the agents to behave in a high-performance way in real-world settings. Training agents to perform well in worst-case settings may allow the agents to perform better in non-worst-case settings.

The first framework system can therefore act as a controller, or a manager that tunes the reward functions or the transition dynamics of the environment. The methods used to modify the reward functions or transition dynamics may include, but are not limited to, gradient-based methods. For example, techniques such as Bayesian optimisation may also be used. Meanwhile, the lower level system may be a multi-agent system that can reach an equilibrium given the reward and/or the transition dynamics that the higher-level agent passes to its agents.

The exemplary algorithm shown in FIG. 5 describes the workflow of the method. Firstly, the HLA selects a vector parameter θ₀ which is its optimization variable. In order to find the optimal θ, the agents are trained on a subgame in which the probability transition function and the reward functions for the agents are determined by θ₀. For the given subgame, the agents are then trained until convergence after which point the reward rᵢ is returned to the HLA. The HLA then performs sequential updates to θₖ until the optimal θ is computed.

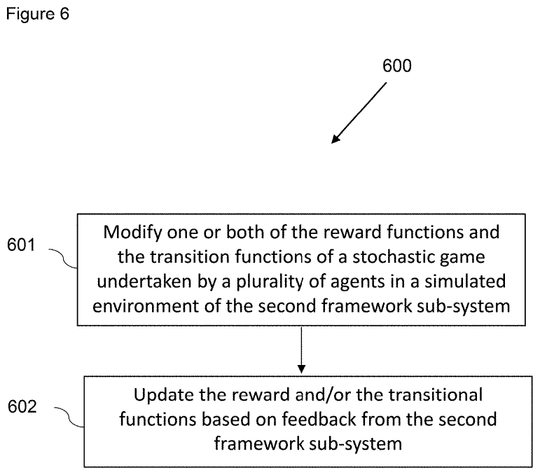

FIG. 6 summarises an example of a computer-implemented method 600 for learning an optimized interacting set of operational policies for implementation by a plurality of agents, each agent being capable of learning an operational policy of the optimized set of operational policies, the system comprising a first framework sub-system and a second framework sub-system. At step 601, the method comprises modifying one or both of the reward functions and the transition functions of a stochastic game undertaken by a plurality of agents in a simulated environment of the second framework sub-system. At step 602, the method comprises updating the reward and/or the transition functions based on feedback from the second framework sub-system.

In a different embodiment, a single agent RL lower level sub-system can be tackled as a degenerate case. In this case, the second framework sub-system comprises a single agent. The behaviour of the lower level agent is driven reinforcement learning and is controlled by the higher level agent in the same manner as is described above. Therefore, including this degenerate implementation, the second framework sub-system may comprise at least one agent that is configured to perform a task in the environment simulated by the higher level agent of the first framework subsystem.

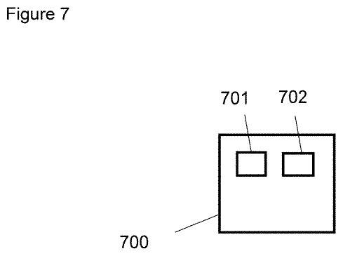

FIG. 7 shows a schematic diagram of a computer system 700 configured to implement the computer implemented method described above and its associated components. The system may comprise a processor 701 and a non-volatile memory 702. The system may comprise more than one processor and more than one memory. The memory may store data that is executable by the processor. The processor may be configured to operate in accordance with a computer program stored in non-transitory form on a machine readable storage medium. The computer program may store instructions for causing the processor to perform its methods in the manner described herein.

The method described herein may be implemented in order to solve at least the following problems under one framework.

Embodiments of the disclosure may result in improved system efficiency. Although MARL algorithms can learn stable policies, in traditional implementations, the system outcomes (described by Nash equilibria) are in general highly inefficient and in practice, often produce poor system outcomes. Indeed, independent MARL agents seek to find actions that optimise their individual rewards. However, in general, in traditional systems, the outcomes produced by the collective behaviour of independent, self-interested agents are in general highly inefficient at a system level. Examples of this (among human agents) can be drawn from congestion in traffic networks and so-called tragedy of the commons within oligopoly. Embodiments of the present disclosure may overcome this problem by the first framework sub-system controlling the lower level agents and having at least one objective external to objective(s) of the plurality of agents of the second framework sub-system.

Embodiments of the disclosure may also help to solve a problem of domain adaptation. As is described herein, MARL algorithms are generally firstly trained on a simulator—a process in which the algorithms learn a sequence of actions in a simulated environment. In order to achieve high performance when deployed in real-world settings, the behaviour of the simulator is required to closely match the behaviour of the real-world system to which the MARL algorithm is to be deployed. In traditional implementations, deploying agents with prefixed policies that have been trained in idealised simulated environments may result in poor performance and unanticipated behaviour when these polices are placed in unfamiliar situations. When policies pretrained on simulated environments are deployed within real-world settings, even slight deviations from the behaviours of the simulated environment can severely undermine performance. System identification, the process by which parameters of a simulator are tuned to match that of a real-world system, is often subject to large errors which can be as a result of unmodelled effects that occur over time. Additionally, unanticipated changes to the system (such as unmodelled wear and tear of the components of a physical system) can lead to MARL algorithms performing inappropriate actions, leading to poor outcomes. Embodiments of the present disclosure may overcome this problem by the first framework sub-system generating a sequence of unseen environments and the agents of the second sub-system learning optimized policies in these environments.

Embodiments of the disclosure may also help to solve a problem of domain design. This problem involves finding optimal actual alterations to an environment in some practical setting so as to achieve some desired outcome. In this way, the method described herein designs optimal alterations to a multi-agent environment without the need for acquiring costly feedback from real-world scenarios. An example is how a central planner should alter the road network by way of traffic signalling or road closures in order to optimise traffic flow through some road network. In such examples, a central planner does not have direct access to the reward functions of independent agents so as to modify their behaviour by choice of rewards. Other examples can be drawn from crowd and fleet management problems and understanding optimal actuator dynamics of autonomous robots. In contrast to existing reward design and principal agent frameworks, embodiments of the system described herein allow a hierarchical agent to tune the transition function of the simulator. This allows the system to tackle the domain design problem: that is, optimizing alterations to system structures. This optimization is performed within a simulator and therefore avoids the need to acquire costly real-world feedback and tackle the domain adaptation problem by finding environment parameters that generate MARL polices that can cope with changes in the environment. In this case, the HLA preferably seeks to construct difficult or worst-case environments which the MARL agents subsequently learn how to behave in.

Owing to the complexity of the problems described above, tackling such problems using analytic theory is in general intractable. Analytic methods require that both the model of the system and reward functions be specified exactly which is often not possible. Moreover, misspecification in the mathematical description can significantly undermine the performance of traditional algorithms.

Prior art systems such as those described in U.S. Pat. No. 8,014,809 B2 and CN105488318 A do not involve bilevel structures. This means that the system alterations are not necessarily guided towards optimal outcomes.

In contrast to that described in EP3605334 A1, the method described herein may advantageously use a gradient-based method that modifies reward functions and the probability transition functions. Additionally, EP3605334 A1 requires the system objective to be known and specified mathematically. In a number of systems such as traffic networks this objective may be too complicated to specify analytically given the numerous parameters and variables. The method described herein however uses reinforcement learning, which does not require the analytic form of the system objective.

Furthermore, in EP3605334 A1, a high level agent only modifies the reward functions of the agents and does not use gradient feedback from the behavior of the system in order to perform its iterative updates. The method in EP3605334 A1 may be less data efficient, since the gradient based information is unexploited. This in turn in general leads to longer training times of the system which produces greater costs. Additionally, EP3605334 A1 requires the system objective to be known and specified mathematically. In a number of systems such as traffic networks, this objective may be too complicated to specify analytically given the numerous parameters and variables.

The bilevel system described herein can therefore optimise both the transition dynamics and reward functions of a multi-agent system. The system performs the task of optimising alterations to system structures in addition to incentives. The system may therefore encompass a gradient-based bilevel multi-agent incentive design system and a gradient-based bilevel transition function design system. The system is also a reinforcement learning system that can search for optimal multi-agent system modifications (reward functions, transition functions). The multi-agent simulator may therefore simulate multi-agent behaviour in diverse environments.

Examples of applications of this approach include but are not limited to: driverless cars/autonomous vehicles, unmanned locomotive devices, packet delivery and routing devices, search and rescue drone systems, computer servers and ledgers in blockchains. For example, the agents may be autonomous vehicles and the policies may be driving policies. The agents may alternatively be communications routing devices or data processing devices.

Modifying the environment (by altering the transition function) affords greater ability to change the system behavior towards an optimum. Considering a traffic scenario in which the high level goal is to reduce congestion, reward-based mechanisms are limited to introducing tolls which is not possible in all traffic network systems. The ability of such a mechanism to produce the desired outcome is also limited. In a traffic system, altering the transition dynamics corresponds to changing traffic light behavior, which is an implementable mechanism in a number of traffic network systems. Moreover, changing traffic light behavior can in some circumstances offer the ability of achieving optimal system outcomes in a way that introducing tolls cannot.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present disclosure may consist of any such individual feature or combination of features. In view of the foregoing description it will be evident to a person skilled in the art that various modifications may be made within the scope of the disclosure.

What is claimed is:

1. A computer-implemented system for learning an optimized interacting set of operational policies for implementation by multiple agents, each of the agents being capable of learning an operational policy of the interacting set of operational policies, the system comprising a first framework sub-system and a second framework sub-system, the first framework sub-system being configured to:
modify one or both of reward functions and transition functions of a stochastic game undertaken by a plurality of the agents in a simulated environment of the second framework sub-system; and
update the reward or the transition functions based on feedback from the second framework sub-system.

2. The computer-implemented system as claimed in claim 1, wherein the first framework sub-system is configured to update the reward functions or the transition functions based on the modification of the one or both of the reward functions and the transition functions.

3. The computer-implemented system as claimed in claim 1, wherein the first framework sub-system is implemented as a higher level reinforcement learning agent and the second framework sub-system is implemented as a multi-agent system, wherein the behaviour of each individual agent, of the agents in the multi-agent system, is driven by multi-agent reinforcement learning.

4. The computer-implemented system as claimed in claim 1, wherein the first framework sub-system comprises a higher level agent and the second framework sub-system comprises a plurality of lower level agents, the higher level agent being configured to modify the one or more of the reward functions and the transition functions of a stochastic game undertaken by the plurality of lower level agents in the simulated environment and update the reward functions or the transition functions based on feedback from the plurality of lower level agents.

5. The computer-implemented system as claimed in claim 4, wherein the higher level agent is configured to iteratively update the reward functions or the transition functions of the plurality of lower level agents based on the feedback from the plurality of lower level agents.

6. The computer-implemented system as claimed in claim 1, wherein the outcome of the stochastic game generates feedback for the first framework sub-system.

7. The computer-implemented system as claimed in claim 1, wherein the second framework sub-system is a multi-agent system, wherein the multi-agent system is configured to reach an equilibrium.

8. The computer-implemented system as claimed in claim 1, wherein the first framework sub-system is configured to modify the reward functions or the transition functions using gradient-based methods.

9. The computer-implemented system as claimed in claim 1, wherein the first framework sub-system has at least one objective external to objective(s) of the plurality of agents of the second framework sub-system.

10. The computer-implemented system as claimed in claim 1, wherein the first framework sub-system is configured to construct a sequence of simulated environments by modifying the reward functions and the transition functions of the stochastic game undertaken by the plurality of agents of the second framework sub-system in each simulated environment.

11. The computer-implemented system as claimed in claim 1, wherein the first framework sub-system is further configured to assess whether the updates to the reward functions and the transition functions have produced a set of optimal policies.

12. The computer-implemented system as claimed in claim 1, wherein the first framework sub-system is configured to generate a sequence of unseen environments.

13. The computer-implemented system as claimed in claim 1, wherein the stochastic game is a Markov game.

14. The computer-implemented system as claimed in claim 1, wherein the plurality of agents of the second framework sub-system are at least partially autonomous vehicles and the policies are driving policies.

15. The computer-implemented system as claimed in claim 1, wherein the second framework sub-system is configured to assign an initial operational policy to each of the plurality of agents of the second framework sub-system.

16. The computer-implemented system as claimed in claim 15, wherein the second framework sub-system is configured to update the initial operational policies based on the feedback.

17. The computer-implemented system as claimed in claim 15, wherein the second framework sub-system is configured to perform an iterative machine learning process comprising repeatedly updating the operational policies until a predetermined level of convergence is reached.

18. The computer-implemented system as claimed in claim 1, wherein the second framework sub-system is configured to generate the feedback based on the performance of the plurality of agents in the simulated environment.

19. A computer-implemented method for learning an optimized interacting set of operational policies for implementation by multiple agents, each of the agents being capable of learning an operational policy of the optimized interacting set of operational policies, the system comprising a first framework sub-system and a second framework sub-system, the method comprising:
modifying one or both of reward functions and transition functions of a stochastic game undertaken by a plurality of agents in a simulated environment of the second framework sub-system; and
updating the reward functions or the transition functions based on feedback from the second framework sub-system.

20. A non-transitory computer-readable storage medium storing in non-transient form a set of instructions for causing a computer to perform the method of claim 19.
